(19) United States
(12) Patent Application Publication
(10) Pub. No.: US 2009/0146409 A1
(43) Pub. Date: Jun. 11, 2009

(54) METHOD FOR CREATING A FORGERY-PROOF CUSTOMISED AND/OR PRINTED GRAPHIC ELEMENT ON A SUPPORT AND SUPPORT THUS OBTAINED

(75) Inventor: Jean-Luc Lesur, Bras (FR)

Correspondence Address: BUCHANAN, INGERSOLL & ROONEY PC, POST OFFICE BOX 1404, ALEXANDRIA, VA, 22313-1404, US

(73) Assignee: Gemplus, Gemenos (FR)

(21) Appl. No.: 12/089,864

(22) PCT Filed: Oct. 3, 2006
(86) PCT No.: PCT/EP2006/067002

§ 371 Date: Aug. 13, 2008

(30) Foreign Application Priority Data
Oct. 11, 2005 (FR) 0553095

(51) Int. Cl. B42D 15/00; B41M 3/14

(52) U.S. Cl. 283/73; 427/7

(57) ABSTRACT

The invention relates to a method of creating a forgery-proof customised and/or printed graphic element on a support using an electromagnetic beam. At least one official marking seal is used which can divert and/or deform an electromagnetic beam. The support is printed or customised using the electromagnetic beam, which is diverted and/or deformed by the official marking seal. The invention also relates to the support thus obtained and to the official marking seal.

The present invention relates to the field of the authentication of a support or a part of the support, using an official seal.

It more particularly relates to a method for creating a forgery-proof customised and/or printed graphic element on a support, using an electromagnetic beam.

The supports preferably concerned by the invention are plastic cards, more particularly, electronic chip cards such as identity cards, driving licenses, personal badges, passports, loyalty cards, health care cards, bank cards and multiple application cards.

However, it can apply to any type of support requiring an authentication or authenticity mark, which can be printed by an electromagnetic beam.

Among the means known for authentifying or certifying a support, an object, an official document or a picture, a resin or a wax sealing, seals or stamps are known in the form of rubber stamps applied on the object of interest directly or through a paste.

The stamp generally includes a relief external surface, reproducing an official pattern called a seal and the image of which is transposed to the object. The transposition is carried out through a pressure intended to deform and/or print an ink onto the surface of the object or the support.

However, forgery consists in reproducing the seal by moulding the print left by the seal on the support.

The seal is generally made in places and/or at times, which are different from those of the customised or printed graphic element, which may give way to opportunities of forgery between the various places and/or times concerned.

In the field of plastic card marking with a laser, it is possible to forge a picture by adding lines thereon, using a laser beam.

The first object of the invention is to provide a method for certifying/authentifying a support using an official seal which should be more difficult to forge.

The second object of the invention consists in providing a method for certifying/authentifying a customised and/or printed graphic element using an electromagnetic beam and more particularly, a laser beam on a support which offers no possibility of forgery any more.

For this purpose, the invention provides a method for creating a forgery-proof customised and/or printed graphic element on a support using an electromagnetic beam.

It is characterised in that it includes the following steps consisting in:
supplying at least one official marking seal capable of diverting and/or deforming the electromagnetic beam,
making the printed and/or customised graphic element of the support using an electromagnetic beam which is diverted and/or deformed by the official marking seal.

According to other characteristics of the method:
the graphic customisation and/or printing is made by an image of the seal itself;
the printed and/or customised graphic element includes at least a transformed part which is diverted and/or deformed by the official marking seal;
the official marking seal has a surface with a relief defining an authentication pattern.

Another object of the invention also consists of a support including a printed and/or customised graphic element; it is characterised in that at least one part of printed and/or customised graphic element represents an official marking seal having grades and/or marking details at least twice as fine as electromagnetic beam marking spots having a diameter equal to 20 μm.

Another object of the invention consists of an authentication official marking seal for a device intended for a customised and/or printed graphic element using an electromagnetic beam; the seal is characterised in that it has a surface with a relief defining an authentication pattern.

Other characteristics and advantages of the invention will appear upon reading the following description, which is given as an illustrative and non-limitative example, and which is made while referring to the appended Figures, wherein:

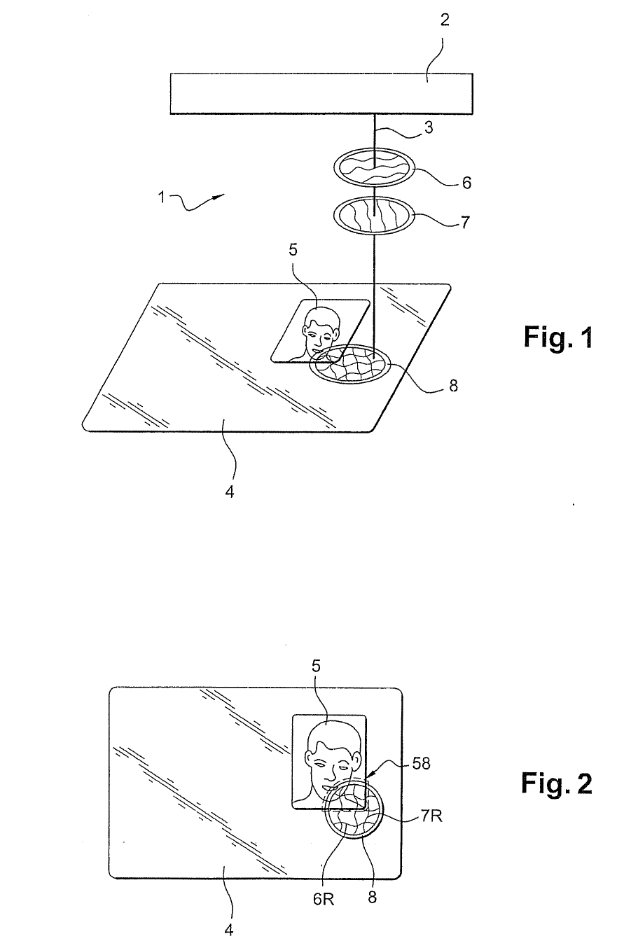

FIG. 1 illustrates a schematic view of a device intended for a customised graphic element for an identity card according to a first embodiment of the method of the invention;

FIG. 2 illustrates a schematic view of a card obtained with an authentication mark;

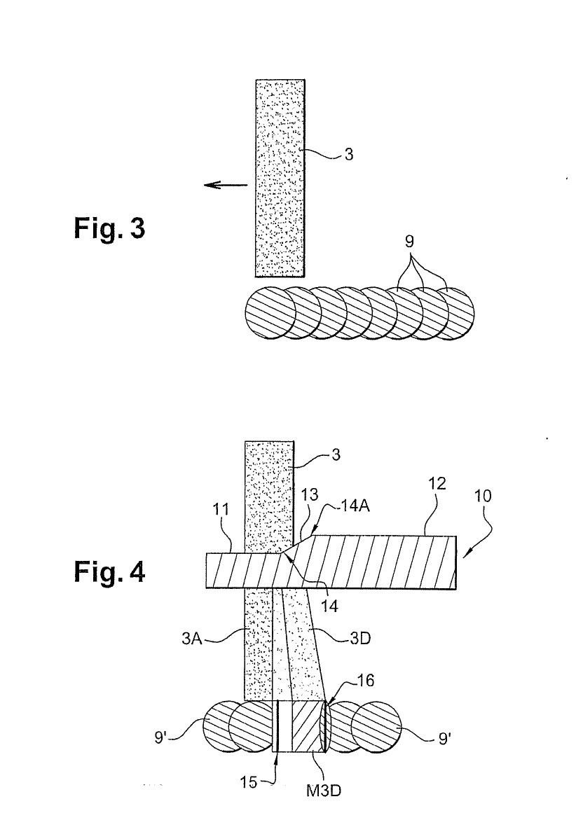

FIG. 3 illustrates a schematic view of a laser marking of the prior art;

FIG. 4 illustrates a schematic view in greater details of a laser marking according to the first embodiment;

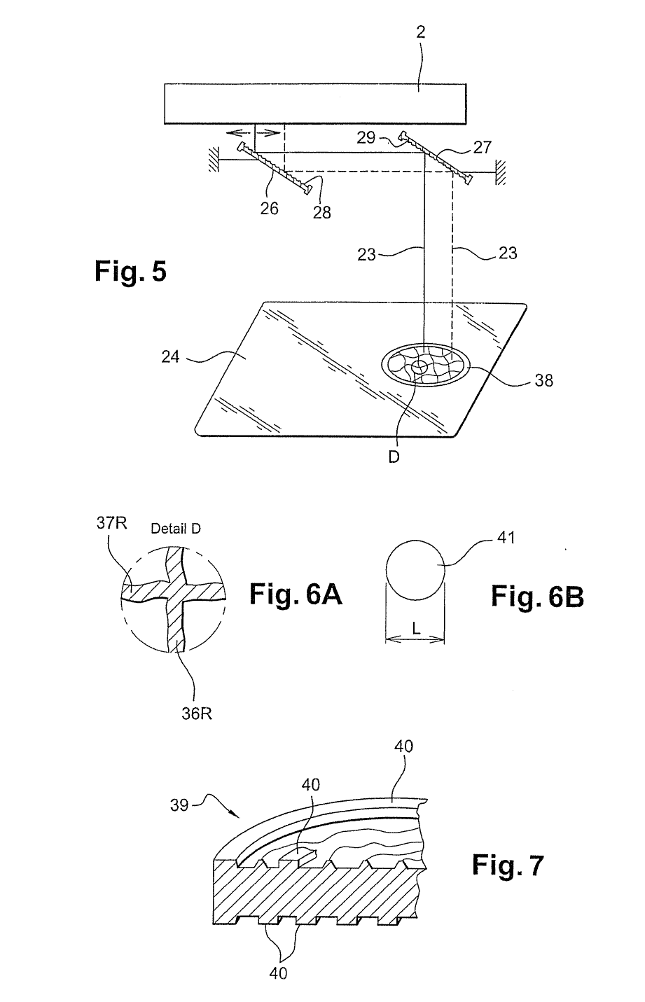

FIG. 5 illustrates a schematic view of a device intended for a customised graphic element for a card according to a second embodiment of the method of the invention;

FIGS. 6A and 6B respectively illustrate a schematic view of a detail of the marking in comparison with the dimensions of a laser spot of the prior art;

FIG. 7 illustrates a partial schematic view of a marking seal used according to the first embodiment.

In FIG. 1, a method for creating a forgery-proof authentication customised and/or printed graphic element on a support 4 is implemented using a customisation device 1, using an electromagnetic beam, i.e. a laser beam.

The device includes a laser beam emitter 2, more particularly, including optical scanning means and focusing means for a laser beam 3.

The beam is intended to irradiate a support 4 such as an identity card in order to print thereon a picture 5 of the cardholder.

The impact of the laser beam on the surface of the support causes a local discolouration, more particularly, under the effect of the thermal energy released (burning) or through the reaction with pigments, reagents or any sensitive component known, such as the titanium oxide contained in the material near the surface of the support.

Thereabout, the invention applies to any black and white or colour marking method using an electromagnetic beam, preferably a laser beam. It applies more particularly to laser type methods using a transparent coating sheet comprising pigments sensitive to laser or those using several superimposed layers of various coloured pigments.

According to the first embodiment, the method provides the supply or use of at least one official marking seal 6.

The marking seal of the invention, contrary to those of the prior art, is an authentication means capable of diverting and/or deforming and/or dispersing an electromagnetic beam in order to mark characteristics likely to be known and checked.

The seal includes beam distribution or spreading means, for example, a transparent body including a relief (cavities, peaks, grooves) with areas or area arrangements, which produce a particular distribution of the beam under the effect of a laser beam; characteristics or specific marks, associated with each area of the relief or corresponding to a specific distribution or spreading of the laser on a surface, are thus obtained. The seal thus makes it possible to make a unique print, representative of the seal, using a laser beam, more particularly, passing through the seal or reflecting thereon.

Such generally heterogeneous and irregular distribution or spreading can be obtained using other means, more particularly, one or several electronic and complex masks or filters, as indicated at the end of the present document, which can be combined in a specific way, in a given order or a different order, depending on the surface unit of the support considered or several surface units of the support intended to be irradiated.

The seal preferably includes or reproduces a set of laser beams/spots diverting or distribution/spreading means. For example, on one of its surfaces, the seal includes a set of geometric characteristics according to a given distribution. Each area of the relief can modify a laser spot in a specific way.

The print of a seal results from the irradiation of a set of laser spots, modified in a different way. Each surface unit of the irradiated support can thus have a graphic signature as regards the seal, which results from the irradiation of one or several modified laser spots.

The marked seal can reproduce an authentication pattern having geometric characteristics, which are also difficult to forge. Thus, the marked seal can, for example, result from the sum of the diversions and/or deformations produced by two different seals arranged randomly with respect to each other, and more particularly superimposed and parallel or inclined with respect to each other.

Their respective setting is recorded so as to mark the supports with the same characteristics.

It can be transparent and, for example, have a relief on the surface representing an authentication pattern.

In the example, a first seal 6 placed on the path of the beam has been made of a transparent resin; it includes irregular scratches in a given direction, whereas a second seal 7 placed downstream from the path under the first one, includes scratches oriented in a direction perpendicular to the previous ones.

According to one step of the method, the marking of the support is carried out using an electromagnetic beam, which has been diverted and/or deformed and/or spread by the seal.

As a matter of fact, in the example, the laser beam goes through the first seal 6 and undergoes slight deviations or spreading when it meets the scratches; then it also goes through the second seal while undergoing other deviations or additional spreading.

The result of the laser printing is illustrated in FIG. 2. A portrait representing the customised graphic element is marked on the support, with a marked seal partially overlapping the portrait and a surface out of the portrait on the body of the card.

Thus, the portrait (5) includes a deformed part (58) which is the result of an image of the portrait deformed by both seals, cumulated with an image of both marking seals.

On the seal mark, which is called a print in the following, respective scratches 6R and 7R of the seals are shown in a cumulative way.

It is not possible or at least it is extremely difficult, with means currently available on the market, to copy a seal more particularly using a scanner since it includes a customised and genuine portion, which can vary from one card to another (corresponding to the intersection of the printed portrait and a print of the seal).

It is not possible either to scan the document in order to duplicate the portrait and the image of the seal because of the limits in the definition of scanners which are currently existing and of the laser beam printing devices, as will be discussed hereinunder, with respect to shading and fineness of the lines obtained.

A printing can be any image, for example, a decoration, a logo etc. While a customisation can be, for example, a picture, a fingerprint, the iris of the eye, or any mark varying with the person or the entity associated thereto.

In FIG. 3, a linear scanning with a laser beam on the support in the direction of the arrow leaves a mark on a support composed of a series of round spots 9 corresponding to a succession of laser spots or laser shootings superimposed and corresponding to the diameter of the beam; each spot corresponds to a laser pulse.

In FIG. 4, a transparent simplified seal 10 is interposed and includes a discontinuous thickness between a lower plane 11 and an upper plane 12 and a junction ramp 13 between the planes.

Such seal is capable of producing at least three characteristic marks.

The intersection of the ramp with the lower plane forms an edge defined by a line 14 perpendicular to the plan of the Figure.

The straight beam 3A produces not deformed spots 9′ on the plane 11 and on the plane 12, whereas the edge 14 produces a very fine profile line 15 projected onto the support along a path of the beam and making a first characteristic mark.

The portion of the beam 3D diverted by the ramp produces a second mark M3D which is different from the round spots 9′, a lighter or darker mark depending on the marking method used (respectively colouration, discolouration or sublimation, extraction of material).

The print of the seal also includes a third mark 16 which results from a summarization of a straight laser mark 9′ through the plane 12 and a diverted beam 3D mark M3D originating from the junction ramp 13. Such mark 16 includes a line corresponding to the projection of an edge 14A located at the junction of the ramp and the upper plane 12.

The succession of these three separate marks is also a characteristic of the print.

The lines 15 and 16 can also have an increased fineness (for example, lower than 10 μm or even 1 μm) with respect to the diameter of elementary spots 9 allowed by the standard laser (for example 20 μm).

The lines 15 and 16 have a greater definition (for example, greater than 2,000 DPI) than the one allowed by the laser beam (for example, 1,000 DPI).

Such lines, which can be seen with a microscope or with a magnifier, are details representing the seal used and make it possible to authenticate the marking.

In FIG. 5, a second implementation of the method uses the same device 2 except for the official authentication means, which have another design than the first marking seals 6, 7.

The second marking seals include more or less reflective and/or absorbing surfaces, in order to produce a diverted and/or faded reflection depending on the incidence of the beam, the materials used in the making of the seals.

For example, the marking seals 26 and 27 include a reflective relief surface 29 respectively including a relief authentication pattern as in the marking seals 6 and 7.

In the device, the seal 26 is positioned so as to receive the beam from the device 2 and send it back onto the seal 27. The beam then undergoes two consecutive reflections and deformations by being diverted or deformed by the scratches existing on the reflective surfaces prior to reaching the support.

Thereabout, only one seal can be appropriate for both embodiments described.

Another difference with the first embodiment lies in the fact that the marking of the support is only performed with a seal so as to authentify the support itself. The image or the print of the seal 38 in itself is then a printed and/or customised graphic element of the corresponding pattern.

Such method makes it possible to authenticate the support itself, such as an official document, a passport sheet, a collection piece from a museum, a painting, jewellery, leather items etc.

However, it is preferable to print through the seal an identifiable and varying graphic element such as, for example, a portrait, in order to improve the security of the authentication.

In FIG. 6A, it is clearly seen that a detailed part of the image representing an official seal has grades and/or marking details 36R, 37R which are finer than the diameter (L) of the laser spots 38 (FIG. 6B) currently used.

The graphic customisation lasers used, at least in the field of chip card or identity card, currently have a beam of the order of 50 μm to 100 μm, the smallest one having a beam of the order of 20 μm.

In FIG. 7, a seal 39 has been made by moulding a coin having the same format, but in a transparent material. The surface of the coin includes surface irregularities, reliefs 40 forming an official pattern. A print obtained with a standard laser through such coin very neatly showed, on a PVC or PET plastic card support, features or geometric details having a width lower than 0.1 μm.

Authentication means (optical official seals) could be formed using other objects such as prisms, crystals, diffraction means, occultation means, internal bubbles or particles, making it possible to obtain the same effect.

If need be, authentication means of the device could be made in a software and/or electronic form. They would, for example include so-called electronic or software masks or seals, driving programs more particularly acting on focusing means, diaphragm, beam spreading means and/or beam intensity fading). Such adapted means could act at the same time on the fineness, the spreading and the grades according to a pre-programmed determined distribution and would correspond to a geometric pattern of the seal.

1. A method for creating a forgery-proof customised and/or printed graphic element on a support using an electromagnetic beam, comprising the following steps:
supplying at least one official marking seal, said seal being an authentication means capable of diverting and/or deforming the electromagnetic beam so as to form an authentication geometric pattern showing a print of the seal and including characteristic marks, and
making the printed and/or customised graphic element of the support using the electromagnetic beam which is diverted and/or deformed by the official marking seal.

2. A method according to claim 1, wherein the customised and/or printed graphic element comprises of an image of the seal itself.

3. A method according to claim 1, wherein the customised and/or printed graphic element includes a transformed part which is diverted and/or deformed by the official marking seal.

4. A method according to claim 3, wherein the customised and/or printed graphic element includes a picture.

5. A method according to claim 1, wherein the official marking seal has a surface with a relief which defines an authentication pattern.

6. A method according to claim 5, wherein said surface of the official marking seal is transparent or reflective.

7. A support comprising an authentication seal obtained according to the method of claim 1.

8. A support comprising a customised and/or printed graphic element, wherein at least a part of the customised and/or printed graphic element represents a geometric pattern corresponding to a print of a marking seal, said print including characteristic marks, said marks having grades and/or marking details at least twice as fine as electromagnetic beam marking spots having a diameter equal to 20 μm.

9. An authentication official marking seal for a device intended for a customised and/or printed graphic element using an electromagnetic beam, said seal being an authentication means capable of diverting and/or deforming the electromagnetic beam so as to form an authentication geometric pattern representing a print of the seal and including characteristic marks, wherein said seal has a surface with a relief defining an authentication pattern.

10. An official authentication seal according to claim 9, wherein the surface is transparent or reflective.
